(19) United States
(12) Patent Application Publication
(10) Pub. No.: US 2026/0297436 A1
(43) Pub. Date: Oct. 1, 2026

(54) Center Feed Nozzle

(71) Applicant: DeltaValve, LLC, Parkway Sandy, UT (US)

(72) Inventor: Nicholas Miller, Sandy, UT (US)

(21) Appl. No.: 19/561,070

(22) Filed: Mar. 9, 2026

Related U.S. Application Data
(60) Provisional application No. 63/768,258, filed on Mar. 7, 2025.

(51) Int. Cl. C10G 9/00; C10B 55/00

(52) U.S. Cl. CPC C10G 9/005; C10B 55/00

(57) ABSTRACT

An improved center feed nozzle with a dual nozzle configuration. A bulge with a curve going downward into the flow pat and then pulling back toward the wall at the first nozzle is formed between the flow source and the first nozzle. An extended partition divides the first nozzle and the second nozzle. The geometry directs flow more evenly between the first nozzle and the second nozzle, thus reducing the plume height as well as the pressure drop without directing the flow into the coke drum walls. The bulge may be hollowed and connected to a steam source to reduce temperature gradients and the fatigue that results therefrom by maintain a more uniform wall thickness heated from both inside and outside.

### PRIORITY APPLICATION

This application claims priority to U.S. Provisional Patent Application No. 63/768,258 filed on Mar. 7, 2025.

### TECHNICAL FIELD

The present disclosure relates generally to refining equipment. More particularly, the disclosure relates to a center feed device nozzle.

### BACKGROUND

Refineries have flow parameters for the flow of process fluids flowing through the refinery equipment. Flow parameters are based on a number of including the grade of crude being processed and the type of coke being produced. As a result, each refinery has a non-standard pressure drop. Flow control nozzles are used to provide feed to a coke drum. Various styles of side feed technology create different flow patterns in the coke drum and coke bed formations. Feed passed through the nozzle and into the coke drum can damage the coke drum if the stream contacts the drum roof or the drum walls. Frlow traditional nozzles generally favor one nozzle over the other. Similarly, traditional nozzles produce a plume whose height that can damage the drum roof or laterally disperse and damage the coke drum walls. Thus a need exists for a nozzle with a reduced pressure drop. A further need exists that produces a plume with a reduced height and reduced lateral spray without introducing fatigue

### BRIEF SUMMARY

The general purpose of the systems and methods disclosed herein is to provide an improved center feed device flow control nozzle, while also promoting coke drum longevity and reducing nozzle fatigue. Specifically, the improved center feed nozzle will pass fluid, such as feedstock, through the nozzle into a center feed device. The nozzle's flow path geometry provides a 20% reduction in pressure drop. The nozzle's flow path geometry further improves the distribution of fluid flow through a first exit port and a second exit port, thus reducing the plume height without damaging the drum wall with fluid. The overall apparatus contains a bulge between the flow source and adjacent first nozzle. This apparatus is designed to work in conjunction with a variety of existing refinery equipment and exit port inserts, but it could also be included in conjunction with new insert structures.

One non-limiting embodiment comprises an improved nozzle for directing fluid in a Retractable Center Feed Injection Device (referred to herein as “CFD”), as sold by DeltaValve®. In some embodiments a flow control nozzle provides side feed to a coke drum by insertion into the coke drum. In some embodiments the nozzle comprises flow path for entry of the feed into the nozzle and two adjacent flow exit ports aligned on a primary axis along the body of the nozzle. In some embodiments the nozzle comprises a flow path with an obstruction, such as a bulge, configured to reduce the cross-sectional area of the flow path. In some embodiments the upstream portion of the bulge comprises a sloped angle configured to substantially maintain a laminar flow. In some embodiments the bulge increases the fluid pressure and velocity flow rate through the constricted flow path. In some embodiments the bulge downstream surface comprises an abrupt angle of approximately 90 degrees terminating the bulge and opening the flow path into an unconstructed flow path with a first and second exit port. In some embodiments the downstream edge of the bulge is configured to create a low pressure in the flow stream further configured to draw feedstock. In some embodiments the bulge is configured to balance the volume of feedstock flowing through the first exit port and the second exit port. In some embodiments a partition 40 separates the first exit port from the second exit port. In some embodiments the partition 40 extends approximately the same length as the bulge 20 at its greatest width. The flow path geometry is configured to reduce the pressure drop. As feed exits the nozzle the plume is kept sufficiently low to not reach the top of the drum by modifying the flow path within the nozzle to balance the flow volume through a first port and a second port, resulting in a more even flow volume through both ports. In some embodiments the nozzle is engineered to maintain a approximately even wall thickness through the nozzle to avoid fatigue.

### BRIEF DESCRIPTION OF THE DRAWINGS

In order to describe the manner in which the advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 shows a detailed cut away view of the nozzle.

FIG. 2 shows a perspective cutaway view of the nozzle with the internal chamber in the bulge.

FIG. 3 shows a perspective cut away view of the nozzle with the flow path along the primary axis through the internal chamber.

FIG. 4 shows an alternative cutaway view of the nozzle.

FIG. 5 shows alternative cutaway embodiments of CFD nozzles.

FIG. 6 shows a method for reduced plume height from a CFD nozzle.

### DETAILED DESCRIPTION OF THE INVENTION

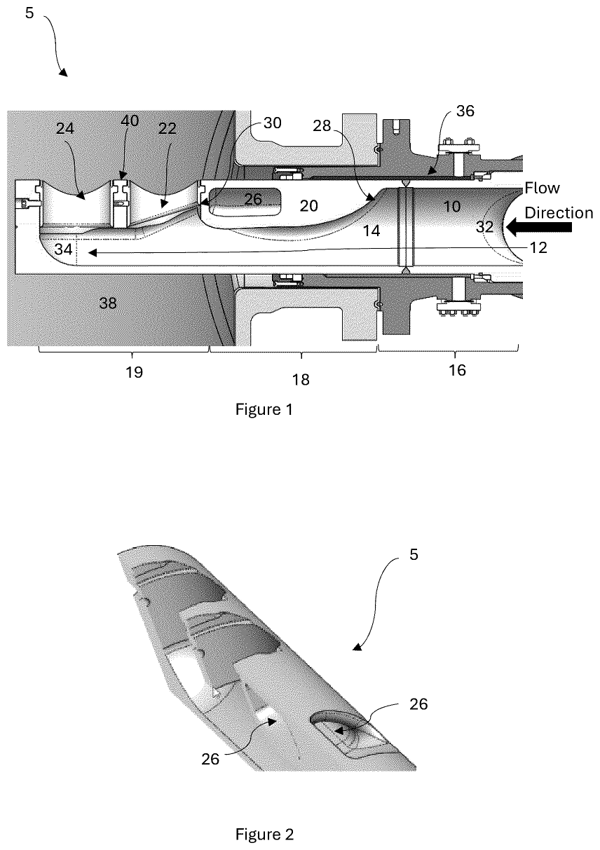

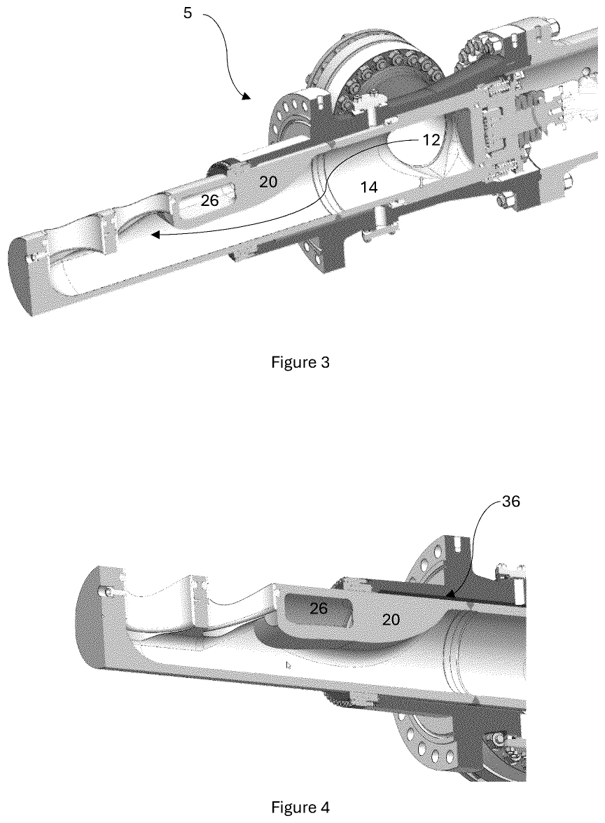

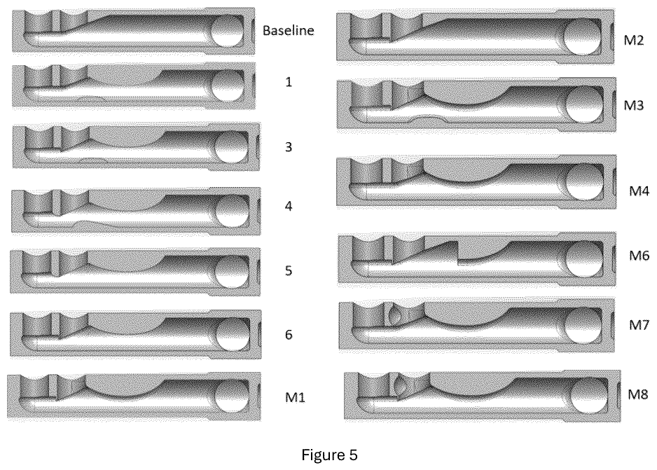

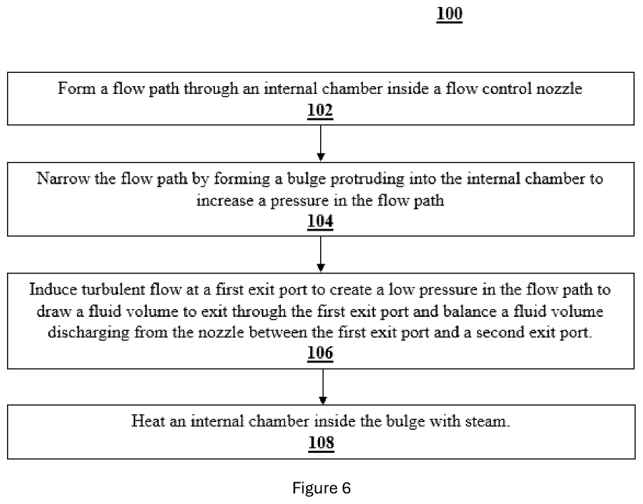

The present embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed descriptions of the embodiments of the apparatus, as represented in FIGS. 1 through 3 are not intended to limit the scope of the invention, as claimed, but are merely representative of present embodiments of the invention.

In general, the figures disclose a CFD nozzle 5 with a bulge to balance the flow volume of feedstock fluid through a first exit port and a second exit port, instead of primarily through one of the exit ports, thus reducing the plume height to protect the coke drum roof and walls. In some embodiments the nozzle disclosed herein comprises a bulge configured to modify the pressures in the flow path. In some embodiments the bulge is configured to induce a low pressure on the down stream side of the bulge during operation, thus drawing fluid into the low pressure. In some embodiments the low pressure is adjacent an exit port, thus fluid or feedstock exits the nozzle through the first exit port.

In the following description, numerous references will be made to a CFD nozzle, a coke drum and feedstock. However, it should be understood that one of ordinary skill in the art and in possession of this disclosure, would readily understand how the present invention and existing refinery structures can be incorporated.

Detailed references will now be made to the preferred embodiments of the present invention, examples of which are illustrated in FIGS. 1-3, which illustrate various views of a CFD nozzle in accordance with one or more embodiments of the invention.

One general aspect includes a CFD nozzle 5 may include a sidewall 10 defining a flow path along the primary axis 12 through an internal chamber 14 configured to guide fluid flow through the internal chamber 14. In some embodiments the flow path through the CFD nozzle 5 may include a first segment 16 that may include a substantially symmetrical cross-section. In some embodiments the first section is standard pipe used to transport feed (also called feedstock, process fluid or fluid) through the refinery.

In some embodiments the nozzle comprises a second segment 18 that may include an asymmetrical cross-section may include a bulge 20. In some embodiments the bulge may comprise a physical protrusion extending from the sidewall 10. In some embodiments the bulge may reduce the cross-sectional area of the flow path between 5% and 75%. In some embodiments the constriction may be between 25% and 60%. In some embodiments the bulge constricts the cross-sectional area of the flow path approximately 35% to 50%. In some embodiments the flow through the first section is laminar. In some embodiments the bulge is configured to disturb the laminar flow and induce turbulent flow. In some embodiments the bulge comprises an internal cavity or internal chamber 26. In some embodiments the internal chamber is in fluid communication with an external steam chamber 36 configured to conduct steam from a steam source (not shown) into the internal chamber 26. Refinery processing is conducted at extremely high temperatures, and inconsistent metal thicknesses on refinery equipment, such as the CFD nozzle 5, may cause temperature gradients to form in the metal. Temperature gradients are known to cause metal fatigue and potential part failure. Thus the bulge 20 in the disclosed nozzle 5 comprises a hollow cavity or internal chamber 26 to maintain a substantially uniform wall thickness across the length of the nozzle 5. In some embodiments the bulge internal chamber 26 is in fluid communication with a steam source. In some embodiments the steam is heated to approximately the same temperature as the process fluid, to heat the sidewall 10 both internally and externally, thus reducing fatigue.

Some embodiments of the nozzle disclosed herein comprises a third segment 19 that may include a first exit port 22 and a second exit port 24. In some embodiments the downstream wall of the bulge 20 forms the upstream sidewall of first exit port 22. In some embodiments the bulge comprises a first side 28 further comprising a ramp, or gradual, sloped ramp of between 1 degree and 60 degrees and gradually decreasing until the bulge external wall is substantially parallel with the opposite sidewall 10. In some embodiments the first side 28 of the bulge is configured to substantially maintain any laminar flow from the first portion 16. In some embodiments the bulge comprises a second side 30. In some embodiments the second side 30 of the bulge 20 comprises an abrupt turn back toward the sidewall 10. In some embodiments the second side 30 is orthogonal to the sidewall 10. In some embodiments second side of the bulge 20 is configured to crease a low pressure in the fluid flow. In some embodiments the low pressure draws process fluid to the low pressure. In some embodiments the second side 30, which also comprises a sidewall of the first exit port 22, thus fluid drawn to the low pressure is discharged through the first port exit 22. Where no bulge is utilized the fluid maintains a constant pressure until hitting the end 34 of the flow path thus the volume of fluid discharged through the second exit port is greater than the volume of fluid discharged through the first exit port. Thus the bulge 20 balances the volume discharge between the first exit port 22 and the second exit port 24. Thus instead of discharging 90% of the fluid volume through the second exit port 24, the geometry of the present flow path discharges between 20% and 60% of the volume of fluid through the first exit port 22 with the balance of fluid discharged from the second exit port. One advantage of this more balanced discharge is a reduced plume height being discharged inside the coke drum 38.

In some embodiments the designation of a segments, as disclosed herein, is independent of any other segment. In some embodiments any one segment may have a length that is greater or less than any other segment. In some embodiments the bulge 20 may be disposed in a single segment, or it may exist in multiple segments. In some embodiments the bulge may form in the first segment 16 and terminate in the third segment 19. In some embodiments the segment may be designated based on a feature, such as a bulge 20 or an exit port 22, 24. In some embodiments the term segment is designated based on fluid flow velocity. In some embodiments the term segment is designated based on fluid pressure. In some embodiments the term segment is designated based on the cross-sectional shape of the flow path.

Implementations may include one or more of the following features. In some embodiments the CFD nozzle 5 the bulge 20 protrudes into the internal chamber 14. In some embodiments the bulge 20 further may include an internal chamber 26 or cavity isolated from the nozzle internal chamber 14. In some embodiments sidewall 10 in the first segment 16 and the sidewall 10 in the second segment are substantially uniform thickness. In some embodiments the bulge 20 internal chamber is configured to be in fluid communication with an external steam chamber 36 and an external source (not shown). In some embodiments the first exit port 22 is adjacent to the bulge 20. In some embodiments the first exit port 22 and the second exit port 24 are adjacent along a primary axis flow path 12 of the nozzle 5. In some embodiments the first exit port 22 and the second exit port 24 are configured to receive inserts.

One general aspect includes a flow control nozzle with a flow path therethrough a nozzle 5 having an internal chamber 14 may include a flow path 12 with a cross-sectional area configured to pass fluid through the internal chamber. In some embodiments the flow path further may include: a first segment16 configured to induce substantially laminar flow; a second segment 18 may include a bulge 20 having a first side 28 and a second side 30 where the first side 28 is upstream 32 of the second side 30, where the bulge 20 is configured to gradually reduce the flow path cross-sectional area between the first side 28 and the second side 30, where the second side 30 of the bulge 20 is configured to induce substantially turbulent flow downstream 34 the second side 30 of the bulge 20; and a third segment 19 may include a first exit port 22 and a second exit port 24 where the first exit port 22 is positioned adjacent the second side 30 of the bulge 20 and the second exit port 24 is aligned with the first exit port 22 along a primary axis flow path 12 formed on the nozzle.

Implementations may include one or more of the following features. In some embodiments the flow control nozzle 5 where the flow path 12 is configured to balance fluid flow volume between the first exit port 22 and the second exit port 24. In some embodiments the flow path 12 is configured to reduce a pressure drop in the nozzle 5. In some embodiments the bulge 20 is asymmetrical going from the first side 28 to the second side 30. In some embodiments the bulge 20 protrudes from a sidewall 28 of the internal chamber 14 into the flow path 12. In some embodiments the bulge may protrude from more than 50% of the circumference of the sidewall 10 in the second segment 18. In some embodiments the bulge 20 may protrude from less than 50% of t he circumference of the sidewall 10 in the second segment 18. In some embodiments the bulge 20 may be bifurcated and protrude from more than one from a portion of the side wall, such that the bulge 20 protrudes from both the top portion of the sidewall 10 and the bottom portion of the sidewall 10 to form a flow channel through the center of the interior chamber 14. In some embodiments each portion of the bulge is manufactured to provide an internal chamber 26 in fluid communication with an external steam source. In some embodiments the nozzle 5 may include substantially uniform wall thickness along the length of the nozzle 5. In some embodiments the bulge 20 wall thickness is substantially uniform. In some embodiments the segmented bulge 20 may include an internal chamber 26. In some embodiments the segmented bulge 20 internal chamber 26 is configured to receive steam. In some embodiments the bulge may include surface features such as fluting, lacuna, or barnacle-like protuberances configured to affect fluid flowing in the flow path 12. In some embodiments the first exit port 22 and the second exit port 24 are configured to receive inserts 28.

In some embodiments a partition 40 divides the first exit port 22 from the second exit port 24. In some embodiments the partition 40 comprises the boundary wall between the first exit port 22 and the second exit port 24. In some embodiments the partition 40 extends a length into the flow chamber. In some embodiments the partition length is approximately the same as the width of the bulge 20. In some embodiments the partition length is greater than the width of the bulge 20. In some embodiments the partition length is approximately less than the width of the bulge 20.

Some embodiments comprise inserts. Each refiner using a CFD system has its own flow parameters. The nozzle as disclosed herein, with its reduced plume height and reduced pressure drop is functional in a wide variety of refinery environments. However, due to the wide variety of refinery demands the nozzle can be further tuned through the installation of custom inserts. Inserts are configured to circumscribe the first exit port 22 and second exit port 24.

Some embodiments comprise a method for controlling a plume height discharged from CFD flow control nozzle. In some embodiments the method also includes forming a flow path through an internal chamber inside a flow control nozzle; narrowing the flow path by forming a bulge 20 protruding into the internal chamber to increase a pressure in the flow path, inducing turbulent flow at a first exit port 22 to create a low pressure in the flow path to draw a fluid volume to exit through the first exit port 22 and balance a fluid volume discharging from the nozzle between the first exit port 22 and a second exit port. Other embodiments of this aspect include corresponding structures and apparatus, each configured to perform the actions of the methods.

Implementations may include one or more of the following features. In some embodiments the method may include improving a fatigue resistance of the nozzle by heating an internal chamber inside the bulge 20 with steam. Implementations of the described techniques may include a method or process.

In closing, it is to be understood that the embodiments of the disclosure disclosed herein are illustrative of the principles of the present disclosure. Other modifications that may be employed are within the scope of the disclosure. Thus, by way of example, but not of limitation, alternative configurations of the present disclosure may be utilized in accordance with the teachings herein. Accordingly, the present disclosure is not limited to that precisely as shown and described.

1. An improved center feed device (CFD) flow control nozzle for directing fluid feedstock into a coke drum, comprising:
a nozzle body having a sidewall defining an internal chamber and a primary flow axis extending therethrough;
a first segment of the internal chamber having a substantially symmetrical cross-sectional flow path;
a second segment downstream of the first segment and including a bulge protruding from the sidewall into the internal chamber so as to reduce a cross-sectional area of the flow path; and
a third segment downstream of the second segment and including a first exit port and a second exit port.

2. The CFD flow control nozzle of claim 1, wherein the bulge is positioned upstream of the first exit port.

3. The CFD flow control nozzle of claim 2, wherein a downstream surface of the bulge forms at least a portion of an upstream boundary of the first exit port.

4. The CFD flow control nozzle of claim 1, further comprising a partition separating the first exit port from the second exit port.

5. The CFD flow control nozzle of claim 4, wherein the partition extends upstream into the internal chamber.

6. The CFD flow control nozzle of claim 5, wherein the partition extends upstream a distance approximately equal to a maximum width of the bulge.

7. The CFD flow control nozzle of claim 1, wherein the bulge includes an upstream surface angled relative to the primary flow axis and configured to gradually decrease the cross-sectional area of the flow path.

8. The CFD flow control nozzle of claim 7, wherein the bulge further includes a downstream surface forming a shoulder relative to the upstream surface.

9. The CFD flow control nozzle of claim 8, wherein the downstream surface is substantially orthogonal to the sidewall.

10. A CFD flow control nozzle for use in delayed coking, comprising:
a nozzle body defining an internal flow path;
a bulge protruding into the internal flow path upstream of a first exit port;
a second exit port positioned adjacent the first exit port; and
a partition separating the first exit port from the second exit port,
wherein the bulge is positioned and configured such that, during operation, a greater proportion of total fluid discharge exits through the first exit port than would occur in an otherwise identical CFD nozzle lacking the bulge.

11. The CFD flow control nozzle of claim 10, wherein the bulge creates a localized low-pressure region adjacent the first exit port during operation.

12. The CFD flow control nozzle of claim 10, wherein between about 20 percent and about 60 percent of total discharge exits through the first exit port during operation.

13. The CFD flow control nozzle of claim 10, wherein the bulge reduces the cross-sectional area of the internal flow path by between about 25 percent and about 60 percent.

14. The CFD flow control nozzle of claim 10, wherein the bulge comprises an internal chamber isolated from the internal flow path.

15. The CFD flow control nozzle of claim 14, wherein the internal chamber is configured to receive steam from an external steam source.

16. The CFD flow control nozzle of claim 15, wherein the internal chamber is configured to reduce temperature gradients in the nozzle body during delayed coking operation.

17. The CFD flow control nozzle of claim 1, wherein the first exit port and the second exit port are configured to receive removable inserts.

18. The CFD flow control nozzle of claim 1, wherein the nozzle body has a substantially uniform wall thickness along the first segment and the second segment.

19. The CFD flow control nozzle of claim 1, wherein the bulge protrudes from less than 50 percent of a circumference of the sidewall.

20. The CFD flow control nozzle of claim 1, wherein the bulge comprises multiple protrusions extending from opposing portions of the sidewall to define a central flow channel.

21.
